(19) United States
(12) Patent Application Publication
(10) Pub. No.: US 2018/0119973 A1
(43) Pub. Date: May 3, 2018

(54) APPARATUS, SYSTEMS AND METHODS FOR SMART AIR SIGNATURE DETECTION AND MANAGEMENT BASED ON INTERNET-OF-THINGS TECHNOLOGY

(71) Applicant: FutureAir, Inc., New York, NY (US)

(72) Inventors: Simone Rothman, New York, NY (US); Jun Shimada, New York, NY (US); Michael Wang, New York, NY (US)

(73) Assignee: FutureAir, Inc., NewYork, NY (US)

(21) Appl. No.: 15/796,544

(22) Filed: Oct. 27, 2017

Related U.S. Application Data
(60) Provisional application No. 62/414,049, filed on Oct. 28, 2016.

(51) Int. Cl. F24F 11/00; G05B 15/02

(52) U.S. Cl. CPC F24F 11/006; G05B 2219/2614; F24F 11/0012; F24F 11/0015; G05B 15/02; F24F 2011/0026; F24F 2011/0027; F24F 2011/0032; F24F 2011/0023; F24F 2011/0024; F24F 2011/0038; F24F 2011/0042; F24F 2011/0071; F24F 2011/0063; F24F 11/0017

(57) ABSTRACT

Apparatus, systems and methods for smart air signature detection and management in at least one room within a building are disclosed herein. In one embodiment, an apparatus for monitoring, reporting and modifying the air in at least one room with at least one entrance/exit door within a building is disclosed. The apparatus comprises a plurality of sensors configured for sensing information related to a plurality of characteristics of the air in at least one room; a processor configured for collecting and processing the information to generate air-related data; and a transceiver configured for communicating the air-related data to a user device of a user and configured for communicating with a network of one or more devices that can modify the air in the at least one room. Systems and methods related thereto are disclosed herein.

### CROSS REFERENCE TO RELATED APPLICATION

This U.S. utility application claims the benefit and priority in and to U.S. provisional application entitled “IOT SYSTEM USING INDOOR AIR QUALITY SIGNATURE DETECTION ENGINE”, U.S. Ser. No. 62/414,049, filed on Oct. 28, 2016, the entirety of which is incorporated herein by reference.

### TECHNICAL FIELD

This disclosure relates generally to smart devices and systems using Internet-of-Things (“IoT”)-related technology, and more particularly relates to apparatus, systems and methods for smart air signature detection and management using IoT technology.

### BACKGROUND

Indoor air quality can be up to five times worse than outdoor air quality, according to the EPA (“Environmental Protection Agency”) in the U.S. and WHO (“World Health Organization”). People spend 90% of their time indoors; yet most of attention has been focused on outdoor air. It has been proven that poor indoor air can cause short-term irritation, discomfort, and decline in productivity, as well as short-term (e.g., irritation to the eyes, nose and/or throat, headaches, fatigue, dizziness) and long-term adverse health effects (e.g., respiratory disease, heart disease, cancer). Poor indoor air can be attributed mostly to harmful gases and particulate matter. The most common form of indoor-generated harmful gases is volatile organic compounds (“VOCs”), which are a combination of any thousands of organic (carbon-containing) chemicals that evaporate (in gaseous state) at room temperature. Further, particulate matter (“PM”) is a complex mixture of extremely small particles and liquid droplets. Examples of potentially harmful PM are mold spores, bacteria, dust mites, dust, PM2.5, insect feces, pollen, smoke, dander, saliva, mucus and other airborne allergens.

Currently, air quality sensors that can accurately count particles and detect specific chemical gases presented in the air are very expensive. More recently, significantly lower cost air quality sensors have the potential to be deployed ubiquitously. However, this new class of lower cost air quality sensors is very broadband, is limited in providing accurate measurements, and is not able to distinguish among different types of pollutants. Particularly, the volatile organic compound (“VOC”) sensors used in majority consumer products cannot accurately identify carbon dioxide from other harmful gases. Without the ability to distinguish between pollutants, it is difficult, if not impossible, to recommend the most effective method to mitigate or eliminate specific pollutants.

Furthermore, one of the most common complaints about indoor spaces is that they are not thermally comfortable; they are frequently too cold or too warm, even when nearly 50% of all building energy costs goes to cooling and heating. One of the problems is that a person's thermal comfort is not based solely on temperature as most rooms are controlled today, but also on relative humidity, the amount of airflow generated by a fan or draft, the metabolic rate of the person, how much clothing the person is wearing, as well as varying cultural and regional preferences of the person. Also, refrigerated air is an unnatural way of cooling that often feels clammy or too cold.

In addition, the existing air sensing and managing systems are not yet connected to be energy efficient, as a large amount of energy is used in controlling cooling, heating, lighting, purifying, ventilation and other load demands in a room or building. These existing systems lack smart connectivity for energy efficiency functionalities, including, without limitation, monitoring energy usage of smart devices in a room (whether individually or in combination), reporting energy usage of such smart devices (whether individually or in combination) and/or modulating energy usage of one or more smart devices in a room based on energy usage and demand on an electrical grid. Further, the existing systems lack the ability to control energy or save energy cost according to different real-time air conditions in a room in the building and/or outside of the building.

As such, there is a need for an apparatus, systems and methods for smart air signature detection and management to overcome the above-mentioned problems.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In an embodiment, an apparatus for monitoring, reporting and modifying the air in at least one room within a building, comprising a plurality of sensors configured for sensing and/or measuring a plurality of characteristics of the air in the at least one room; a processor configured for collecting and processing the plurality of characteristics to generate air-related data; and a transceiver configured for communicating the air-related data to a user device of a user and configured for communicating with a network of one or more devices that can modify the air in the at least one room.

In a further embodiment, the plurality of sensors comprises a particulate matter sensor configured for measuring the amount of solid particles and/or liquid droplets in the air.

In a further embodiment, the plurality of sensors further comprises one or more additional sensors configured for measuring the amount of at least one or more volatile organic compounds (“VOCs”), carbon dioxide, carbon monoxide, methane gas, or a combination thereof in the air, and wherein the solid particles and/or liquid droplets are mold spores, bacteria, dust mites, dust, PM2.5, insect feces, pollen, smoke, dander, saliva, mucus, other airborne allergens, or a combination thereof.

In a further embodiment, the apparatus further comprises a micro-fan configured for taking the air into the particulate matter sensor and/or one or more additional sensors.

In a further embodiment, the plurality of sensors further comprises a thermal comfort sensor configured for measuring the following characteristics of the air: temperature; humidity; pressure; amount of airflow, or a combination thereof.

In a further embodiment, the plurality of sensors comprise a particulate matter sensor configured for measuring the amount of particulates in the air, an air temperature sensor, an air humidity sensor, and a volatile organic compound (“VOC”) sensor configured for measuring the amount of organic chemicals that evaporate at room temperature, wherein the organic chemicals comprise carbon dioxide, carbon monoxide, methane, or a combination thereof.

In a further embodiment, the apparatus further comprises a power supplying mechanism that includes an internal battery, a power supply wire, an external battery connector, a wireless charging unit configured for charging the apparatus wirelessly, or combination thereof.

In a further embodiment, the network of one or more devices comprises an air conditioner, a fan, an air purifier, an electrically-switched window, an electrically-switched shades, an ventilation system, an air humidifier, an AC filter, or a combination thereof, and the one or more devices communicate with the transceiver via a wireless interface comprising Wi-Fi, Bluetooth, near-field communication (“NFC”), 3G, 4G, 5G, ZigBee, Z-Wave, Thread, Insteon, IFTTT, or a combination thereof.

In a further embodiment, the transceiver is further configured for communicating with a controlling device via the wireless interface, wherein the controlling device is configured for controlling the network of one or more devices to turn on/off, power up/down, and/or close/open based on the air-related data.

In a further embodiment, the controlling device controls the network of one or more devices to turn on/off, power up/down, and/or close/open based on one or more machine learning algorithms that are personalized based on personal data of the user and/or at least one threshold associated with the air-related data.

In a further embodiment, the controlling device is further configured for classifying types of pollutants detected in the air based on the air-related data and one or more machine learning algorithms that are personalized based on personal data of the user and/or at least one threshold associated with the air-related data.

In a further embodiment, the apparatus further comprises a display that shows a status of the managed air, a warning related to the managed air, or a combination thereof.

In another embodiment, a method for monitoring, reporting and modifying the air in at least one room within a building, comprising sensing information related to a plurality of characteristics of the air in the at least one room; collecting and processing the information to generate air-related data; and wirelessly communicating the air-related data to a user device of a user.

In a further embodiment, wherein sensing information a plurality of characteristics of the air in the at least one room comprises measuring the amount of solid particles and/or liquid droplets in the air; measuring the amount of organic chemicals that evaporate at room temperature, wherein the organic chemicals comprise carbon dioxide, carbon monoxide, methane, or a combination thereof and measuring air temperature; air humidity; air pressure; amount of airflow, or a combination thereof.

In a further embodiment, the method further comprising communicating with a network of one or more devices in at least one room and/or in the building, via a wireless interface comprising Wi-Fi, Bluetooth, near-field communication (“NFC”), 3G, 4G, 5G, ZigBee, Z-Wave, Thread, Insteon, IFTTT, or a combination thereof, wherein the network of one or more devices comprises an air conditioner, a fan, an air purifier, an electrically-switched window, an electrically-switched shades, an ventilation system, an air humidifier, an AC filter, or a combination thereof.

In a further embodiment, the method further comprising communicating with a controlling device via the wireless interface, wherein the controlling device is configured for controlling the network of one or more devices to turn on/off, power up/down, and/or close/open based on the air-related data, one or more machine learning algorithms, and at least one threshold associated with the air-related data.

In a further embodiment, the controlling device is further configured for classifying types of pollutants detected in the air based on the air-related data and one or more machine learning algorithms that are personalized based on personal data of the user and/or at least one threshold associated with the air-related data.

In another embodiment, a system for monitoring, reporting and modifying the air in at least one room within a building, comprising at least one user device of a user; at least one IoT sensing unit, a network of one or more air modification devices, and a controlling device, wherein the at least one user device, the at least one IoT sensing unit, the plurality of devices, and the controlling device are connected to each other via a wireless network.

In a further embodiment, the IoT sensing unit comprises a particulate matter sensor configured for measuring the amount of solid particles and/or liquid droplets in the air; one or more volatile organic compound sensors configured for measuring the amount of organic chemicals that evaporate at room temperature, wherein the organic chemicals comprise carbon dioxide, carbon monoxide, methane, or a combination thereof; one or more thermal comfort sensors configured for measuring air temperature, air humidity, air pressure, amount of airflow, or a combination thereof; and a transceiver configured for communicating with at least one user device, the network of one or more air modification devices, and the controlling device via a wireless interface comprising Wi-Fi, Bluetooth, near-field communication (“NFC”), 3G, 4G, 5G, ZigBee, Z-Wave, Thread, IFTTT, or a combination thereof, and wherein the network of one or more air modification devices comprises an air conditioner; a fan, an air purifier, an electrically-switched window, an electrically-switched shades, an ventilation system, an air humidifier, an AC filter, or a combination thereof.

In a further embodiment, the controlling device is configured for controlling the at least one air modification device to turn on/off, power up/down and/or close/open based on the air related data, one or more machine learning algorithms, and at least one threshold associated with the air related data; and classifying types of pollutants detected in the air based on the air-related data and one or more machine learning algorithm that are personalized based on personal data of the user and/or at least one threshold associated with the air-related data.

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIGS. 1A-1C illustrate three exemplary variations for placement of a smart air conditioning (“AC”) filter on a window AC unit, in accordance with some embodiments of the present disclosure.

FIG. 2 depicts an exemplary IoT sensing unit with a plurality of sensors (sensors 212, 213, 214), wherein the IoT sensing unit can be a standalone smart device or can be placed within an exemplary smart AC filter or other air modification devices (smart or otherwise), in accordance with some embodiments of the present disclosure. “PM 0.01-100” means particulate matter having particle sizes from approximately 0.1 μm to approximately 100 μm. In another embodiment, it can be “PM 0.01-10,” meaning particulate matter having particle sizes from approximately 0.1 μm to approximately 10 μm. The particulate matter sensor shown herein can include an internal microfan to actively bring air into the sensor for increased sensor reading accuracy.

FIG. 3 depicts an exemplary smart AC unit with the IoT sensing unit attached to and detachable from the smart AC filter frame, in accordance with some embodiments of the present disclosure.

FIG. 4 depicts another exemplary smart AC unit with the IoT sensing unit attached to and detachable from the smart AC unit, in accordance with some embodiments of the present disclosure.

FIG. 5 depicts yet another exemplary smart AC unit wherein the smart AC filter is constructed with no frame and cut-to-fit filter material depending on the size of the smart AC unit, in accordance with some embodiments of the present disclosure.

FIG. 6 depicts an exemplary IoT ecosystem in communication with an exemplary IoT sensing unit, a smart AC unit, a smart fan, a smart purifier and other smart air modification devices in accordance with some embodiments of the present disclosure. The exemplary smart devices can already be smart-ready or where an IoT sensing unit can be added.

FIG. 7A depicts an exemplary algorithm performed by the IoT ecosystem, in accordance with some embodiments of the present disclosure.

FIG. 7B depicts an exemplary algorithm performed by an air signature detection engine, which is part of the algorithm performed by the IoT ecosystem, in accordance with some embodiments of the present disclosure.

FIGS. 8A-8C illustrate three exemplary variations of a ceiling fan with a filter and an IoT sensing unit, in accordance with some embodiments of the present disclosure.

FIG. 9 depicts an exemplary IoT ecosystem in communication with a smart ceiling fan, a smart air filter, a smart AC unit, a smart purifier and other smart air modification devices, in accordance with some embodiments of the present disclosure. The exemplary smart devices can already be smart-ready or include an IoT sensing unit.

FIG. 10 depicts another exemplary IoT sensing unit 1000 with a plurality of sensors 1012, 1013 and 1014, which can be a standalone smart device or can be placed within an exemplary smart AC filter or other air modification devices, in accordance with some embodiments of the present disclosure. “TVOC” means total volatile organic compounds; “CO₂” means carbon dioxide; “CO+CH₄” means carbon monoxide +methane gas; and “PM 0.01-100” means particulate matter having particle sizes from approximately 0.1 μm to approximately 100 μm. In another embodiment, it can be “PM 0.01-10,” meaning particulate matter having particle sizes from approximately 0.1 μm to approximately 10 μm. The particulate matter sensor shown herein can include a microfan to actively bring air into the IoT sensing unit or one or more sensors in the IoT sensing unit for increased sensor reading accuracy.

### DETAILED DESCRIPTION OF EXEMPLARY EMBODIMENTS

Various exemplary embodiments of the present disclosure are described below with reference to the accompanying Figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise. The terminology used herein is used for describing certain embodiments and is not intended to limit the disclosure.

The present disclosure relates to an apparatus, methods and systems that monitor and improve via modification of one or more air-related characteristics (e.g., but not limited to, increasing or decreasing temperature, humidity, amount of gases (e.g., but not limited to, VOCs, carbon dioxide, carbon monoxide, methane, and other harmful gases), amount of airborne allergens, and/or amount of other pollutants) related to thermal comfort and air quality in a room within a building, and wherein the room has at least one entrance/exit door. The room can also include at least one window. The apparatus, methods and systems disclosed herein can also monitor and improve energy efficiency via modification of energy usage of one or more smart devices or systems in communication with the IoT ecosystem disclosed herein The apparatus, methods and systems disclosed herein is based on IoT, which is a network of uniquely-identifiable and purposed “things” that are enabled to communicate data over a communications network without requiring human-to-human or human-to-computer interaction. The “thing” in the “IoT” can be anything that fits into a common purpose thereof. For example, for air signature detection and management, a “thing” could be any device that can sense, control, monitor, or modify the one or more characteristics of the air, directly or indirectly. In one embodiment, the device can be a smart device (an electronic device that is in communication with other devices and/or one or more networks via different wireless protocols (including, but not limited to, Bluetooth, near-field communication (“NFC”), Wi-Fi, 3G, 4G, 5G, ZigBee, Z-Wave, Thread, IFTTT, etc) that can operate to an extent interactively and autonomously), and can be assigned with a unique IP address and provided with the ability to communicate data with other smart devices over a network.

In one embodiment, an IoT ecosystem is disclosed, which comprises a wireless sensing platform, a cloud server and/or one or more cloud edge devices, a cloud-based and/or cloud edge-based analytics engine, and an air signature detection engine that can create unique signatures for air quality and pollutant types and initiate actions (or smart solutions), e.g., through application programming interfaces (APIs), and provide recommendations or solutions for specific air-related problems. The IoT ecosystem can include machine-learning capabilities that play a role in effectively and efficiently computing and identifying air signatures that require corrective actions to improve air quality, comfort and energy efficiency. In one embodiment, support vector machines (“SVM”), or similar supervised learning methods, are used to train a linear and/or non-linear classifier that can distinguish between air signatures that require corrective actions from those that do not. This SVM classifier will take in linear and/or non-linear combinations of air characteristics (e.g., but not limited to, temperature, humidity, VOC, dust) as inputs to produce a multi-dimensional air signature that has a statistical correlation with undesirable air quality characteristics, such as human discomfort, poor work productivity, or unhealthy respiratory measures. The accuracy of this classifier can improve as the IoT ecosystem is deployed and trained in an increasingly diverse set of environments. Other supervised learning methods, such as artificial neural networks and naive Bayes, can also be used to produce similar classifiers.

The IoT ecosystem can also include an intuitive mobile app and/or a web-based dashboard to inform (e.g., but not limited to, providing information in text and/or graphical form (e.g., but not limited to, bar graphs, line graphs, pie charts, other graphical forms or a combination thereof) one or more characteristics of the air (e.g., temperature, humidity, VOC, dust, carbon dioxide, carbon monoxide) in a particular room at any given time point during a particular hour, day or week), improve (e.g., but not limited to, information on one or more actions by the IoT ecosystem and/or by a user to modify the air in a particular room), and provide users with actionable insight on air quality, thermal comfort and/or energy efficiency. The IoT ecosystem can automatically control, permit one or more users to manually control, or a combination thereof one or more smart devices (including air modification devices) that indirectly or directly modify one or more characteristics of the air in one or more rooms within a building. In one embodiment, the wireless sensing platform comprises a plurality of IoT sensors each of which is connected to or in communication with at least one air modification device in the IoT ecosystem. The full potential of these IoT sensors is to inform people on sources of indoor air pollution and other air-related characteristics (e.g., but not limited to, humidity, temperature, air pressure) in live and/or work spaces; provide information for smart systems to dynamically control existing air modification devices (e.g., but not limited to, ventilation systems, air purifiers, AC, HVAC, filters, windows, curtains, shades, fans, air humidifiers); and suggest product and lifestyle changes to a user via the mobile app or web-based dashboard (e.g., provide suggestions to vacuum more often; substitute plant-based cleaning fluids, change or add an air modification device; close or open windows). In another embodiment, the IoT ecosystem can collect and process outdoor-related information at one or more geo-locations from third-party sources regarding one or more characteristics of outdoor air surrounding or nearby the managed room or building, as well as other information such construction sites, electrical utility sites, explosions, fires, outdoor weather, outdoor humidity, winds, etc. that can influence (directly or indirectly) the air inside one or more managed rooms within a building. Further, the IoT ecosystem can use such outdoor-related information to determine one or more solutions to modify the air inside one or more managed rooms. For example, if there is a high-level of dust in the outdoor air relative to the air inside the managed room or building, the IoT ecosystem will not actively open the smart window or ventilation system to bring in outdoor air into the one or more managed rooms. Additionally, the IoT sensing unit and/or IoT ecosystem described herein can be configured to communicate emergency air-related alerts based on the air-related data to an owner, building manager, superintendent, building management, resident, nearby fire station, police and/or other relevant authorities.

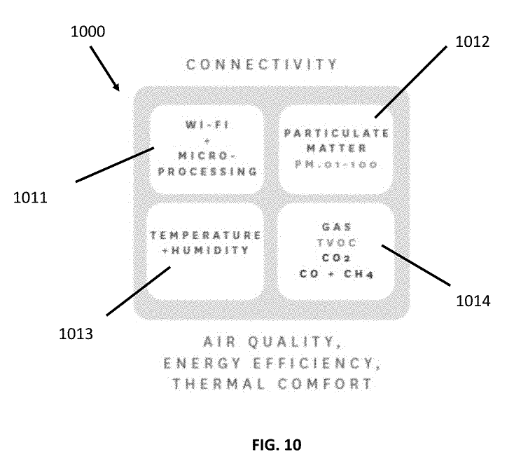

There does not currently exist an apparatus, method or system that both inform and provide air quality management through multiple device connectivity. For example, the AC filters present in the market do not have smart capabilities, due to two problems: 1) most people do not know that the filter exists in their AC unit or when to replace it, and 2) people do not know what pollutants are in their indoor air and what to do about them. Accordingly, an exemplary smart AC filter system is disclosed herein based on the above cost-effective IoT ecosystem. The smart AC filter is equipped with an IoT sensing unit that is wirelessly connected to or in communication with the IoT ecosystem. With the smart AC filter installed on a AC unit, the AC unit can automatically monitor air quality, air pollutant signatures, and thermal comfort levels using an IoT sensing unit (e.g., depicted in FIG. 2 or 10, and communicate such air-related data wirelessly with user devices or other air modification devices in the IoT ecosystem in real-time. In addition, based on a mathematical classifier (i.e., algorithm) trained on a supervised machine-learning method (such as SVM), the cloud server in the IoT ecosystem can automatically turn on/off, power up/down and/or open/close the AC unit and/or other air modification devices, e.g., a fan, humidifier, and/or an air purifier, according to different air-related data detected in real-time. The algorithm can be tailored to each user's unique environment and personal tolerance levels of air quality measures. In one embodiment, it is desirable to implement this algorithm in the IoT sensing unit or in the devices of the IoT ecosystem with low CPU clock speed, the algorithm can be built using linear classifiers, which can prioritize computational speed over accuracy. In another embodiment, if it can tolerate slight delays in the response time of the IoT ecosystem, the algorithm built with non-linear classifiers can be deployed in the cloud servers, which can prioritize accuracy over speed. There are various embodiments of the smart AC filter, which can include a potential filter frame, the IoT sensing unit, and filter material.

In an exemplary embodiment, the IoT sensing unit may comprise temperature, humidity, pressure sensors, air quality sensors (e.g., but not limited to, sensors for sensing and/or measuring the amount of particulate matter (“PM”), volatile organic compounds (“VOCs”), carbon monoxide, carbon dioxide, methane gas) and an accelerometer or a subset thereof. The IoT sensing unit can be integrated with any hardware devices or exist as a standalone product. The IoT sensing unit can be installed onto or into a wall or placed on a table top, desktop, sidetable, or any flat surface. Again, exemplary embodiments of the IoT sensing unit can be found in FIG. 2 or 10.

In an exemplary embodiment, a smart fan that integrates the same IoT ecosystem is disclosed. Although there are fans that can control temperature, a smart ceiling fan that filter air and controls for thermal comfort and air quality does not currently exist in the market. Typically, a fan cools through convection and an AC cools through refrigeration. Convection is a method of cooling where air passing over the skin evaporates or carries away body heat. By contrast, cooling air through use of refrigerants (such as hydrofluorocarbons (“HFCs”)) demands a more energy and pollution intensive method that oftentimes results in overcooling. A smart fan that can connect to or in communication with other air modification devices and an IoT sensing unit can combine these processes to become healthier, more comfortable and energy efficient.

A smart ceiling fan that is connected to or in communication with the IoT ecosystem, as disclosed herein, can provide thermal comfort in an energy efficient manner through a hybrid system of convection (from the fan) and refrigeration (from the AC) for optimal environmental conditions and avoids overcooling. The smart ceiling fan is also capable of monitoring, managing and filtering air, which has not been done before and can disrupt the fan and purifier markets. A ceiling fan is typically more centrally located in a room and as opposed to a standalone air purifier, which typically sits on the floor in the corner of a room. A fan, which naturally creates airflow, combined with a smart filter has the potential to provide a comparable clean air delivery rate to a standalone purifier. This eliminates the need for products taking up space and consuming unnecessary energy in a room. It can be understood that embodiments of the fan or smart fan are not limited to the ceiling fan but can be incorporated into other fan variations.

### EXAMPLES

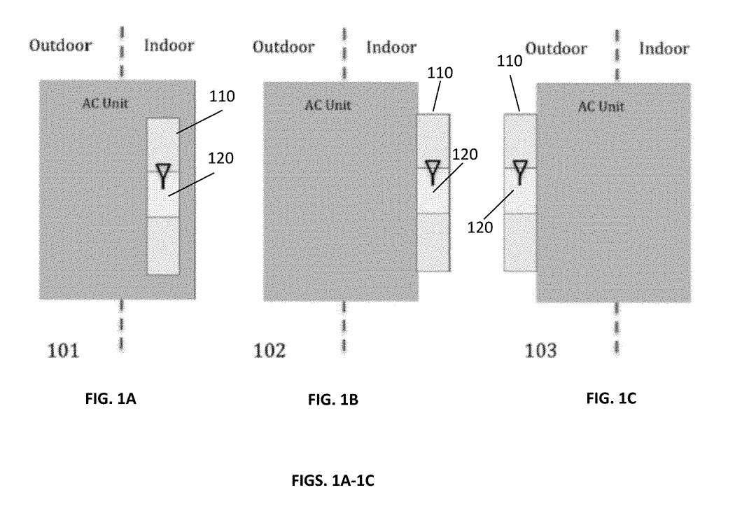

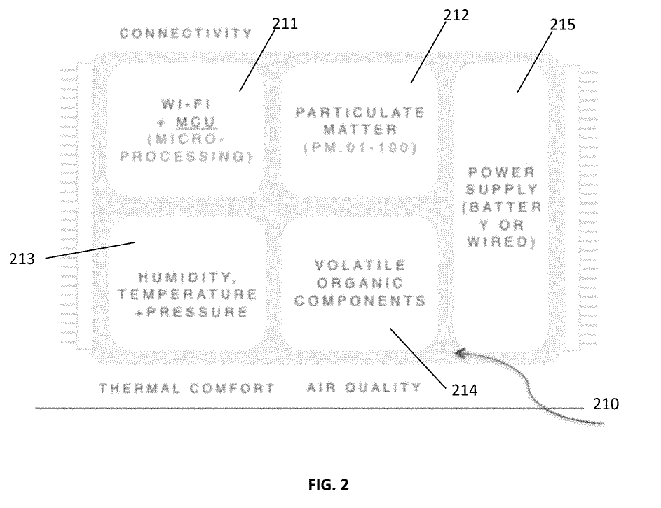

FIGS. 1A-1C illustrate three exemplary variations for placement of a smart air conditioning (“AC”) filter on a window AC unit, in accordance with some embodiments of the present disclosure. The AC filter design variation 101 has the smart AC filter 110 indoors and inside the filter compartment, replacing existing filters. The AC filter design variation 102 has the smart AC filter 110 indoors and on the outside of the AC unit. The AC filter design variation 103 has the smart AC filter 110 outdoors and on the outside of the AC unit. Although this depiction is for a window AC, the smart AC filter 110 has the potential to become integrated into other systems such as but not limited to Heating Ventilation and Air Conditioning (“HVAC”) and Packaged Terminal Air Conditioning (“PTAC”) AC systems. The smart AC filter 110 in each of the three examples includes an IoT sensing unit 120 that can sense the air through the filter and communicate air related information with other devices, e.g., user devices and/or air modification devices, in the IoT ecosystem in real-time. The IoT sensing unit 120 can sense (detect and/or measure) air at any geo-location (including room and/or building), and communicate to a user device of a user associated with the geo-location. For example, the air may be indoor air within a building or a room within a building, and the user is associated with the building or room, e.g., by being an owner, building manager, superintendent, building management, or resident.

FIG. 2 depicts an IoT sensing unit 201 that can be placed within the smart AC filter 110 or as a standalone unit, in accordance with some embodiments of the present disclosure. The IoT sensing unit 210 may be a Wi-Fi enabled PCB (printed circuit board) sensing platform that utilizes cost-effective sensors. In this example, the IoT sensing unit 210 includes a Wi-Fi-based MCU (microcontroller unit) 211 for micro-processing; a particulate matter (“PM”) sensor 212 which measures solid particles and liquid droplets of sizes between 0.01-100 micrometers; a humidity, temperature, airflow and pressure sensor 213; and one or more volatile organic compounds (“VOC”) sensors 214 which can sense and/or measure: carbon dioxide (“CO₂”), carbon monoxide (“CO”) and/or methane (“CH₄”), or any organic chemicals that evaporate at room temperature. In one embodiment, the PM sensor 212 may include a micro-fan (not shown) configured for taking the air into the PM sensor 212 or other sensors in the IoT sensing unit for air measurement. The IoT sensing unit 210 can also potentially include a power supply mechanism 215, which can be a battery within the unit or an external power source, such as but not limited to a power supply wire, an external battery power connector, or a wireless charging unit configured for charging the apparatus wirelessly. In one embodiment, the IoT sensing unit 210 can also include one or more light-emitting diodes (“LEDs”) that can light the IoT sensing unit and/or display/notify the user a status of the managed air, a warning related to the managed air, and/or that the IoT ecosystem is beginning to, in the process of, ending process of modifying the air. FIG. 10 depicts another IoT sensing unit, which includes a power supply mechanism 215 (not shown) and a plurality of sensors (sensors 212, 213 and 214) sensing and/or measuring different characteristic of the air, such as temperature, humidity, particulate matter, VOC or TVOC, carbon dioxide (“CO₂”), carbon monoxide (“CO”) and methane gas. The IoT sensing unit 1000 is in connected to one or more air modification devices and can sense and/or monitor energy usage of one or more air modification devices and assist the IoT ecosystem in determining and achieving energy efficiency goals within the smart air signature detection and management system.

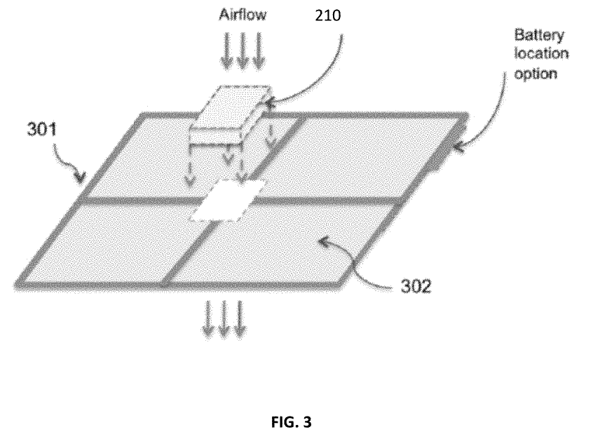

FIG. 3 depicts an exemplary smart AC unit where the IoT sensing unit 201 is attached to and detachable from the smart AC filter frame 301, in accordance with some embodiments of the present disclosure. FIG. 3 illustrates an embodiment of the smart AC filter with the IoT sensing unit 201 placed in the middle of the filter frame 301. The IoT sensing unit 210 is used for air quality detection and control. There is a hole in the center of the smart AC filter where the IoT sensing unit 210 can be attached and detachable. The IoT sensing unit 210 can either be battery powered or powered through a power supply wire connected to the AC unit or the wall. The battery can also either be attached to the IoT sensing unit as shown in FIG. 2 or attached to the air filter frame 301. The air filter material 302 can potentially be a combination of high efficiency particulate air (“HEPA”), carbon, electrostatic, or polarized media filter. The air filter material 302 is not limited to these particular filter types and can be broadened to other material and types. The filter itself may be replaceable and new filters can be re-attached to the IoT sensing unit 201 and placed into the AC unit.

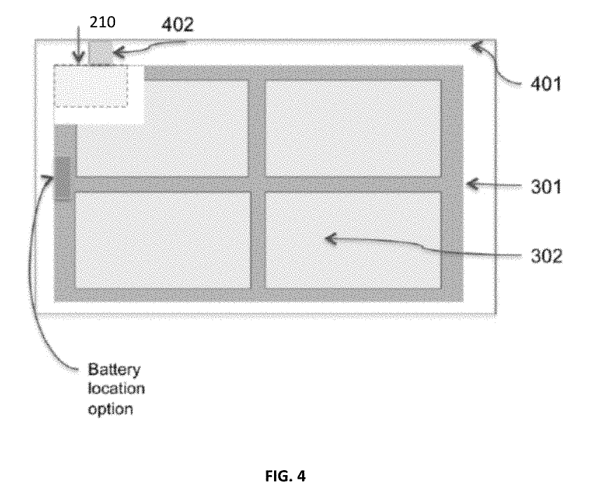

FIG. 4 depicts another exemplary smart AC unit where the IoT sensing unit 201 is more securely attached to the AC unit, in accordance with some embodiments of the present disclosure. FIG. 4 illustrates a second embodiment for the smart AC filter construction where the IoT sensing unit 210 can be more securely attached through an attachment module 402 to somewhere on the interior filter compartment of the AC unit 401, and detachable from the smart AC filter. FIG. 4 shows an example of the IoT sensing unit 210 in the corner of the AC unit 401. Other variations of the locations of the IoT sensing unit 210 are also possible according to various embodiments. The IoT sensing unit 210 can be powered either through battery or power supply wire. The battery can either be placed but not limited to within IoT sensing unit 210 or air filter frame 301.

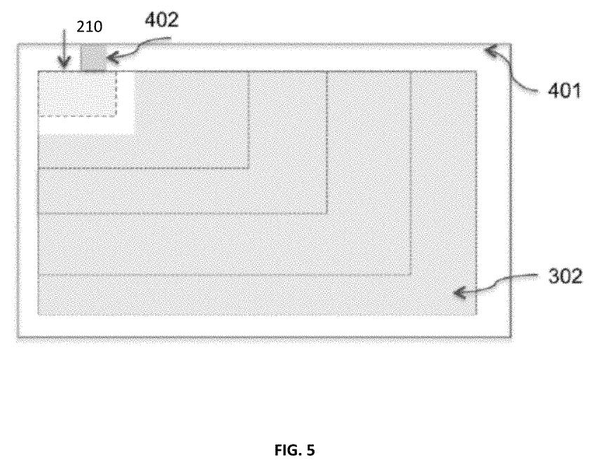

FIG. 5 depicts yet another exemplary smart AC unit where the smart AC filter is constructed with no frame and cut-to-fit filter material depending on the size of the AC unit, in accordance with some embodiments of the present disclosure. FIG. 5 illustrates a third embodiment for the smart AC filter construction where there is no air filter frame 301 to support the IoT sensing unit 210. IoT sensing unit 210 can be attached securely to the interior filter compartment of the AC unit 401 through an attachment module 402 and detachable from the filter material 302. The filter material 302 can be cut-to-size depending on the size of the AC unit 401. The IoT sensing unit 210 can be powered either through a battery or power supply wire. The battery can either be placed but not limited to within the IoT sensing unit 210 or the filter material 302.

Table 1 below summarily displays exemplary variations for the smart AC filter construction.

TABLE 1

| | Sensor Location and | |
|---|---|---|
| Filter Frame | Configuration | Power Source |
| Framed filter | Sensor in middle | Battery powered |
| | | through IoT |
| | | sensing unit |
| Framed filter | Sensor in the middle | Wired to AC unit or |
| | | wired to wall |
| Framed filter | Sensor in the middle | Battery power |
| | | through filter |
| Framed filter | Sensor anywhere | Battery powered |
| | else (i.e. corners) | through IoT |
| | | sensing unit |
| Framed filter | Sensor anywhere | Wired to AC unit |
| | else (i.e. corners) | or wired to wall |
| Framed filter | Sensor anywhere | Battery power |
| | else (i.e. corners) | through filter |
| No frame | Detachable sensor | Battery powered |
| (cut to fit | from filter | through IoT |
| AC unit size) | | sensing unit |
| No frame | Detachable | Battery power |
| (cut to fit AC | sensor from filter | through filter |
| unit size) | | |
| No frame | Detachable | Wired to AC |
| (cut to fit AC | sensor from filter | unit or wired |
| unit size) | | to wall |
| No frame | Detachable | Battery powered |
| (cut to fit AC | sensor, attached | through IoT |
| unit size) | to AC unit | sensing unit |
| No frame | Detachable | Battery |
| (cut to fit AC | sensor, attached | power through |
| unit size) | to AC unit | filter |
| No frame | Detachable | Wired to AC |
| (cut to fit AC | sensor, attached | unit or wired |
| unit size) | to AC unit | to wall |

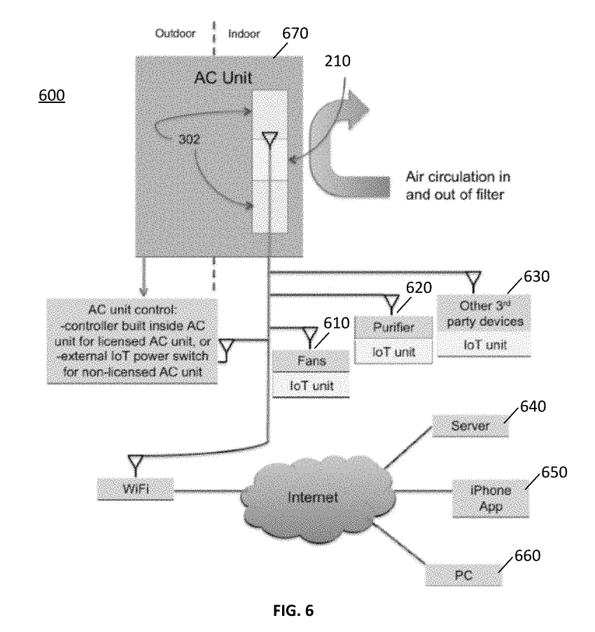

FIG. 6 depicts an exemplary IoT ecosystem 600 in relation to a smart AC unit 670, in accordance with some embodiments of the present disclosure. As shown in FIG. 6, air will flow through the filter material 302 and the IoT sensing unit 210. The IoT sensing unit 210 can collect information related to the one or more characteristics of the air and process the information to generate air-related data. Then through Wi-Fi or other communication protocols, the IoT sensing unit 210 can connect with a smart fan 610, AC unit 670, a purifier 620, third party devices 630, a smartphone app 650, a server 640 and a personal computer (“PC”) 660. The filter, and hence the AC unit 670, connected with the IoT sensing unit 210 can also connect to other air modification devices. It allows the user to maximize use of an AC unit through not only thermal comfort, but also air purification while gaining actionable insight. To regulate thermal comfort and cooling, the IoT ecosystem 600 can connect to and control the fan 610 and/or the AC unit 670. To control air quality, the IoT ecosystem 600 can connect to and control the purifier 620. It can be understood that the IoT ecosystem 600 may also include other air modification devices, e.g., but not limited to, an electrically switched window that can be opened or closed based on the air related data detected by the IoT sensing unit 210; building ventilation system.

In one embodiment, the IoT sensing unit 210 can communicate, via a transceiver on the IoT sensing unit 210, with a network of devices as shown in FIG. 6 that can modify the air, through a wireless interface other Wi-Fi, e.g., but not limited to, 3G, 4G, 5G, Bluetooth, NFC, ZigBee, Z-Wave, Thread, Insteon, IFTTT. The server 640 or a plurality thereof can serve as a controlling device configured for controlling the air modification devices in FIG. 6 to turn on/off, power up/down, and/or open/close based on the air-related data obtained by the IoT sensing unit 210. The IAQ signature detection engine 702 and data analysis engine 703 can be in server 640 (or a plurality thereof), or can be in the cloud edge comprising one or more cloud edge devices (e.g., but not limited to, an IoT sensing unit, any IoT device that is connected to or in communication with the IoT sensing unit via wireless or wired connectivity, any user device (such as a smartphone, a tablet, a laptop, a wearable tech device (e.g., smart watch, smart glasses), PC, localized server). The one or more cloud edge devices can also serve as a controlling device configured for controlling the air modification devices to turn on/off, power up/down, and/or open/close based on the air-related data obtained by the Iot sensing unit.

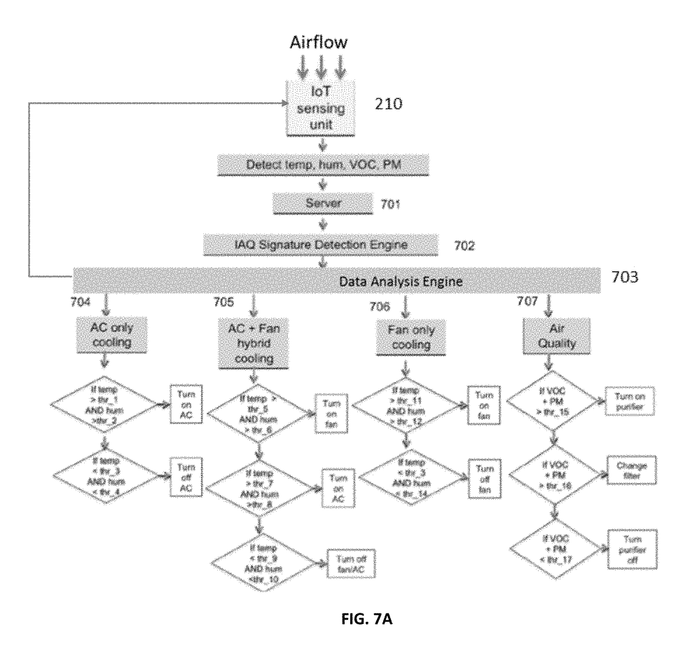

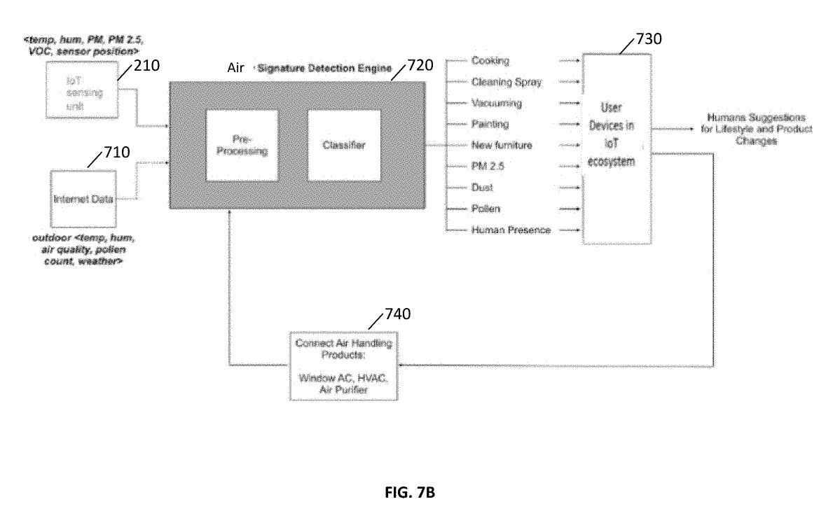

FIG. 7A depicts another exemplary algorithm performed by the IoT ecosystem, e.g., the IoT ecosystem 600 in FIG. 6, via a standalone IoT sensing unit 210, in accordance with some embodiments of the present disclosure. As air flows onto and into the IoT sensing unit 210, the sensors detect temperature, humidity, VOC or tVOC, and PM, and such sensor information flows through to the server 701, the Indoor Air Quality (“IAQ”) Signature Detection Engine 702, and the data analytics engine 703. The data analytics engine 703 can be divided into 2 areas: a thermal comfort area (704, 705, 706), and air quality (707). The data analytics engine 703 can also include an additional area—energy efficiency. In one embodiment, the server 701, the Indoor Air Quality Signature Detection Engine 702, and the data analytics engine 703 are located in the cloud in the IoT ecosystem, and are connected to the IoT sensing unit 210 via a wireless interface, e.g., but not limited to, Wi-Fi, 3G, 4G, 5G, Bluetooth, NFC, ZigBee, Z-Wave, Thread, Insteon, IFTTT. Each of the server 701, the IAQ Signature Detection Engine 702, and the data analytics engine 703 can transmit data to and receive data from the AC unit and/or other IoT air modification devices as shown in FIG. 6.

As shown in FIG. 7A, for thermal comfort, the data analytics engine is divided into three modes: AC only 704, AC +fan hybrid mode 705, and fan only mode 706. For AC +fan hybrid mode 705, the AC will turn on after the temperature sensor detects temperature greater than threshold 1 and a humidity reading greater than threshold 2. The AC will turn off after the temperature sensor detects temperature below threshold 3 and a humidity reading of less than threshold 4. For AC +fan hybrid mode 705, the connected fan will turn on if the temperature sensor detects temperature greater than threshold 5 and humidity greater than threshold 6. The AC will turn on with a temperature greater than threshold 7 and humidity greater than threshold 8. The fan and AC will turn off when the temperature is less than threshold 9 and humidity is less than threshold 10. For fan only mode 706, the fan will turn on if the temperature is above threshold 11 and humidity is above threshold 12, and turn off if the temperature detected is lower than threshold 3 and humidity is lower than threshold 14.

Because turning air cooling off when humidity is low will significant reduce energy consumption, the algorithm disclosed herein can make the disclosed air modification system based on the IoT ecosystem energy efficient compared to existing air modification system. Furthermore, the IoT ecosystem can connect to a Wi-Fi enabled electrical outlet or plug, which can be electrically connected to an air modification device, and obtain energy usage information and/or control the energy usage or turn on/off any air modification device electrically connected to the Wi-Fi enabled electrical outlet or plug.

Continuing on FIG. 7A, for air quality control mode 707, the purifier will turn on after a combined threshold of 15 has been reached for VOC and PM. The user will be alerted to change the filter after VOC and PM readings are above threshold 16. The purifier will turn off if the VOC and PM readings are below threshold 17. FIG. 7A also illustrates a graphic example of when the system would turn the AC on/off in accordance with different thresholds under different modes.

The network of devices connected to the IoT sensing unit 210 in the IoT ecosystem can be turned on/off, powered up/down, and/or open/closed based on an algorithm and at least one threshold associated with the air-related data. For example, FIG. 7A shows the network of devices being turned on/off via an algorithm and at least one threshold associated with the air-related data. The algorithm can be formed and updated based on machine learning techniques, such as a variety of Bayesian and non-Bayesian techniques, support vector machines, K-means clustering, artificial neural networks, and can be personalized based on personal data of the user, e.g., the user's habits related to air quality and modification (which includes manual inputs by the user) throughout a period of time.

FIG. 7B depicts an exemplary algorithm performed by an air signature detection engine, which is part of the algorithm performed by the IoT ecosystem, in accordance with some embodiments of the present disclosure. FIG. 7B illustrates how an air signature detection engine 720, which may be an IAQ Signature Detection Engine 702, recognizes the full potential of a new class of lower cost air quality sensors by aggregating multiple sensor and real-time outdoor air quality data streams 710 to determine the unique signatures of indoor air pollutants categories and activities such as but not limited to: (1) pollen, (2) coarse grain PM, (3) fine grain PM 2.5, (4) high VOC activity (household cleaning supplies, painting, cooking), and (5) human presence (e.g., CO₂). The real-time outdoor air quality data streams 710 can include third-party data from the Internet.

In one embodiment, these air signature data can be sent to user device(s) 730 connected to the IoT sensing unit 210 in the IoT ecosystem. The user device(s) 730, e.g., a smartphone, a tablet, a laptop, a wearable tech device (e.g., smart watch, smart glasses), or a PC, can provide suggestions to a user for lifestyle and product changes. For example, a suggestion can be: reducing oil usage during cooking, opening windows more frequently, changing bedsheets, reducing or stop smoking, using plant-based cleaning products, adding a particular air modification device, or the like.

In another embodiment, these air signature data can also be sent, directly or through the user devices 730, to other IoT sensing units connected to air modification devices 740 in the IoT ecosystem, e.g., one or more IoT sensing units connected to an electric fan, an air purifier, a window AC, HVAC, smart ventilation system and/or a smart window that can modify air and are connected to the same wireless network as the IoT sensing units 210. The air modification devices 740 can send feedback data to the air signature detection engine 720 to inform about the air modification operation(s) taken by the air modification devices 740.

In one embodiment, the Wi-Fi-connected IoT sensing unit 210 takes measurements of the indoor air, sends the streams of measurement data to a cloud server for data calibration and analytics, and leverages proprietary algorithms to communicate with and control other existing air modification products (e.g., HVAC, window air conditioner, fans, purifiers) to improve air quality, energy efficiency and thermal comfort. The air signature detection engine 720, as illustrated in FIG. 7B, comprises a data preprocessing unit and a data classifier. The data preprocessing unit can take measurements of air characteristics (e.g., but not limited to, temperature, humidity, VOC, dust) as inputs to produce linear and/or non-linear multi-dimensional air signatures according to a mathematical formula derived from SVMs, or similar supervised learning method. The data classifier, which can be derived from SVMs or similar supervised learning methods, can be trained to distinguish air signatures with undesirable air quality characteristics, such as unhealthy respiratory measures, versus those that do not. According to various embodiments, the air signature detection engine 720 can utilize various machine learning techniques to help isolating the signatures and patterns of each class of air pollutant, such as a variety of Bayesian and non-Bayesian techniques, support vector machines, K-means clustering, artificial neural networks, to achieve a sufficiently discriminative model. The machine learning algorithm used by the air signature detection engine 720 can be personalized based on personal data of the user, e.g., the user's habits related to air quality and modification throughout a period of time.

As discussed above, a ceiling fan can be integrated with the disclosed smart filter and the disclosed IoT ecosystem. The utility of this integration relates to monitoring and informing the user of air quality, as well as connecting with other devices and affecting air flow/circulation within a room. As the fan moves air in the environment, it can pull airflow through the filter and IoT sensing unit. The fan itself can address both thermal comfort in an energy efficient manner by utilizing a hybrid convection and refrigeration system, as well as air quality.

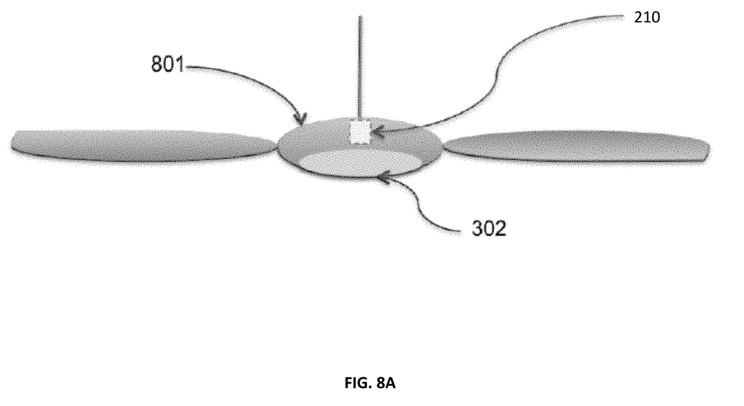

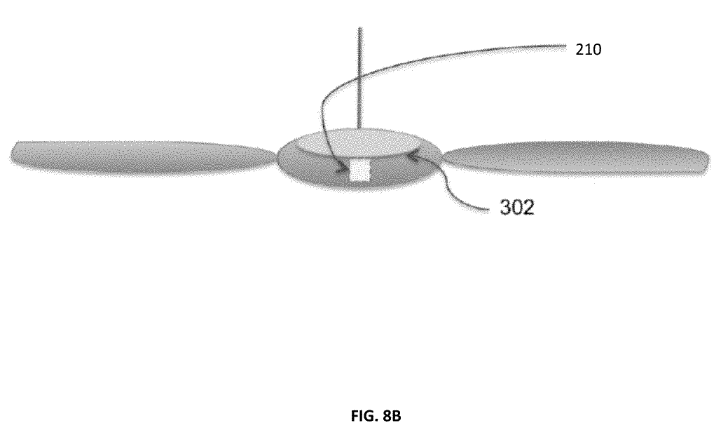

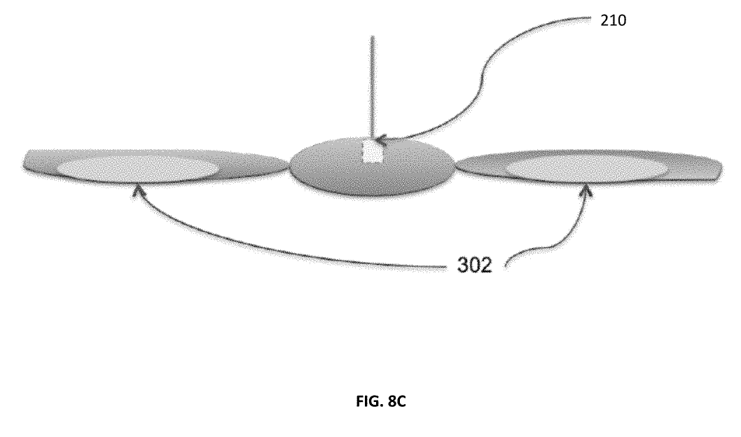

FIGS. 8A-8C illustrate three exemplary variations of a ceiling fan 801 with a filter 302 and an IoT sensing unit 210, in accordance with some embodiments of the present disclosure. FIG. 8A shows a variation where the filter 301 is on the bottom of the fan 801. The IoT sensing unit 210 can also be placed either within the fan, on the fan, or as a separate standalone unit. It can either be battery powered or powered through a power supply wire to the wall. FIG. 8B shows a variation where the filter 302 is on the top of the fan. The IoT sensing unit 210 can also be placed in the similar locations as described for FIG. 8A. FIG. 8C shows a variation where the filters 302 are placed on the wings of the fan. The IoT sensing unit 210 can also be placed in the similar locations as described for FIG. 8A.

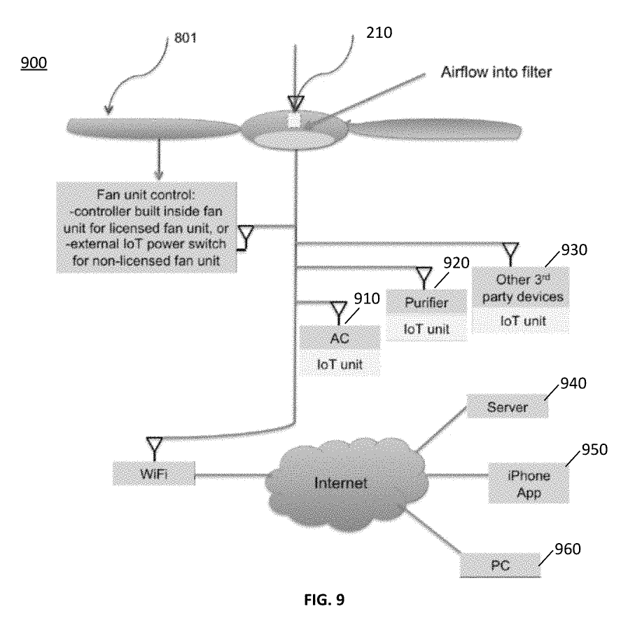

FIG. 9 depicts an IoT ecosystem 900 in relation to a ceiling fan and smart filter system, in accordance with some embodiments of the present disclosure. FIG. 9 illustrates the smart ceiling fan and filter integrated in the IoT ecosystem 900 with the ceiling fan shown in FIG. 8A. The air circulation pulled in from the ceiling fan will allow airflow over the IoT sensing unit 210. The IoT sensing unit 210 will connect through Wi-Fi (or other wireless interfaces) to control air-handling devices a subset of which includes an AC unit 910 and a purifier 920 and connect to the cloud to the server 940, a mobile app 950, and a PC 960. The IoT ecosystem 900 can utilize the algorithm as shown in FIG. 7A.

It is to be understood that the above-described embodiments are merely illustrative of a variety of other embodiments that may constitute applications of the principles of the disclosure. Such other embodiments may be readily devised by those skilled in the art without departing from the spirit or scope of this disclosure and it is our intent they be deemed within the scope of our disclosure.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (“IC”) that can include a general purpose processor, a digital signal processor (“DSP”), an application specific integrated circuit (“ASIC”), a field programmable gate array (“FPGA”) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. An apparatus for monitoring, reporting and modifying the air in at least one room within a building, comprising:
a plurality of sensors configured for sensing and/or measuring a plurality of characteristics of the air in the at least one room;
a processor configured for collecting and processing the plurality of characteristics to generate air-related data; and
a transceiver configured for communicating the air-related data to a user device of a user and configured for communicating with a network of one or more devices that can modify the air in the at least one room.

2. The apparatus of claim 1, wherein the plurality of sensors comprises a particulate matter sensor configured for measuring the amount of solid particles and/or liquid droplets in the air.

3. The apparatus of claim 2, wherein the plurality of sensors further comprises one or more additional sensors configured for measuring the amount of at least one or more volatile organic compounds (“VOCs”), carbon dioxide, carbon monoxide, methane gas, or a combination thereof in the air, and wherein the solid particles and/or liquid droplets are mold spores, bacteria, dust mites, dust, PM 2.5, insect feces, pollen, smoke, dander, saliva, mucus, other airborne allergens, or a combination thereof.

4. The apparatus of claim 3, further comprising a micro-fan configured for taking the air into the particulate matter sensor and/or one or more additional sensors.

5. The apparatus of claim 4, wherein the plurality of sensors further comprises a thermal comfort sensor configured for measuring the following characteristics of the air: temperature; humidity; pressure; amount of airflow, or a combination thereof.

6. The apparatus of claim 1, wherein the plurality of sensors comprise a particulate matter sensor configured for measuring the amount of particulates in the air, an air temperature sensor, an air humidity sensor, and a volatile organic compound (“VOC”) sensor configured for measuring the amount of organic chemicals that evaporate at room temperature, wherein the organic chemicals comprise carbon dioxide, carbon monoxide, methane, or a combination thereof.

7. The apparatus of claim 1, further comprising a power supplying mechanism that includes an internal battery, a power supply wire, an external battery connector, a wireless charging unit configured for charging the apparatus wirelessly, or combination thereof.

8. The apparatus of claim 1, wherein the network of one or more devices comprises an air conditioner, a fan, an air purifier, an electrically-switched window, an electrically-switched shades, an ventilation system, an air humidifier, an AC filter, or a combination thereof, and the one or more devices communicate with the transceiver via a wireless interface comprising Wi-Fi, Bluetooth, near-field communication (“NFC”), 3G, 4G, 5G, ZigBee, Z-Wave, Thread, Insteon, IFTTT, or a combination thereof.

9. The apparatus of claim 1, wherein the transceiver is further configured for communicating with a controlling device via the wireless interface, wherein the controlling device is configured for controlling the network of one or more devices to turn on/off, power up/down, and/or close/open based on the air-related data.

10. The apparatus of claim 9, wherein the controlling device controls the network of one or more devices to turn on/off, power up/down, and/or close/open based on one or more machine learning algorithms that are personalized based on personal data of the user and/or at least one threshold associated with the air-related data.

11. The apparatus of claim 9, wherein the controlling device is further configured for classifying types of pollutants detected in the air based on the air-related data and one or more machine learning algorithms that are personalized based on personal data of the user and/or at least one threshold associated with the air-related data.

12. The apparatus of claim 1, further comprising a display that shows a status of the managed air, a warning related to the managed air, or a combination thereof.

13. A method for monitoring, reporting and modifying the air in at least one room within a building, comprising:
sensing information related to a plurality of characteristics of the air in the at least one room;
collecting and processing the information to generate air-related data; and
wirelessly communicating the air-related data to a user device of a user.

14. The method of claim 13, wherein sensing information a plurality of characteristics of the air in the at least one room comprises:
measuring the amount of solid particles and/or liquid droplets in the air;
measuring the amount of organic chemicals that evaporate at room temperature, wherein the organic chemicals comprise carbon dioxide, carbon monoxide, methane, or a combination thereof; and
measuring air temperature; air humidity; air pressure; amount of airflow, or a combination thereof.

15. The method of claim 14, further comprising communicating with a network of one or more devices in at least one room and/or in the building, via a wireless interface comprising Wi-Fi, Bluetooth, near-field communication (“NFC”), 3G, 4G, 5G, ZigBee, Z-Wave, Thread, Insteon, IFTTT, or a combination thereof, wherein the network of one or more devices comprises an air conditioner, a fan, an air purifier, an electrically-switched window—an electrically-switched shades, an ventilation system, an air humidifier, an AC filter, or a combination thereof.

16. The method of claim 15, further comprising communicating with a controlling device via the wireless interface, wherein the controlling device is configured for controlling the network of one or more devices to turn on/off, power up/down, and/or close/open based on the air-related data, one or more machine learning algorithms, and at least one threshold associated with the air-related data.

17. The apparatus of claim 16, wherein the controlling device is further configured for classifying types of pollutants detected in the air based on the air-related data and one or more machine learning algorithms that are personalized based on personal data of the user and/or at least one threshold associated with the air-related data.

18. A system for monitoring, reporting and modifying the air in at least one room within a building, comprising:
at least one user device of a user; at least one IoT sensing unit, a network of one or more air modification devices, and a controlling device, wherein the at least one user device, the at least one IoT sensing unit, the plurality of devices, and the controlling device are connected to each other via a wireless network.

19. The system of claim 18, wherein the IoT sensing unit comprises:
a particulate matter sensor configured for measuring the amount of solid particles and/or liquid droplets in the air;
one or more volatile organic compound sensors configured for measuring the amount of organic chemicals that evaporate at room temperature, wherein the organic chemicals comprise carbon dioxide, carbon monoxide, methane, or a combination thereof;
one or more thermal comfort sensors configured for measuring air temperature, air humidity, air pressure, amount of airflow, or a combination thereof; and
a transceiver configured for communicating with at least one user device, the network of one or more air modification devices, and the controlling device via a wireless interface comprising Wi-Fi, Bluetooth, near-field communication (“NFC”), 3G, 4G, 5G, ZigBee, Z-Wave, Thread, IFTTT, or a combination thereof, and wherein the network of one or more air modification devices comprises an air conditioner; a fan, an air purifier, an electrically-switched window, an electrically-switched shades, an ventilation system, an air humidifier, an AC filter, or a combination thereof.

20. The system of claim 19, wherein the controlling device is configured for:
controlling the at least one air modification device to turn on/off, power up/down and/or close/open based on the air related data, one or more machine learning algorithms, and at least one threshold associated with the air related data; and
classifying types of pollutants detected in the air based on the air-related data and one or more machine learning algorithm that are personalized based on personal data of the user and/or at least one threshold associated with the air-related data.
